(19) United States
(12) Patent Application Publication
(10) Pub. No.: US 2016/0108489 A1
(43) Pub. Date: Apr. 21, 2016

(54) TRANSPORT DEVICE AND METHOD FOR TRANSPORTING HOT AND THIN-WALLED STEEL PARTS

(71) Applicant: THYSSENKRUPP STEEL EUROPE AG, Duisburg (DE)

(72) Inventors: Sascha SIKORA, Lünen (DE); Janko BANIK, Altena (DE)

(73) Assignee: THYSSENKRUPP STEEL EUROPE AG, Duisburg (DE)

(21) Appl. No.: 14/894,767

(22) PCT Filed: Apr. 24, 2014
(86) PCT No.: PCT/EP2014/058318

§ 371 Date: Nov. 30, 2015

(30) Foreign Application Priority Data
May 28, 2013 (DE) 10 2013 105 488.9

(51) Int. Cl. C21D 9/00; H05B 3/00; H05B 6/14

(52) U.S. Cl. CPC C21D 9/0018; H05B 6/145; H05B 3/0095

(57) ABSTRACT

Disclosed is a transporting device for transporting steel parts for hot forming and/or hardening, having transporting receptacles in which the steel parts are disposed and which are specified for transporting steel parts having temperatures of more than 650° C. The invention moreover relates to a method for transporting steel parts from a device for heating the steel parts to a device for hardening, hot forming, or press hardening the steel parts, wherein the steel part in a first step in a device for heating is heated to a predetermined first temperature which is above room temperature.

The invention relates to a transporting device for transporting steel parts for hot forming and/or hardening, having transporting receptacles in which the steel parts are disposed and which are specified for transporting steel parts having temperatures of more than 650° C. Moreover, the invention relates to a method for transporting steel parts from a device for heating the steel parts to a device for hardening, hot forming, or press hardening the steel parts, wherein the steel part in a first step in a device for heating is heated to a predetermined first temperature which is above room temperature.

In the manufacture of components made from heat-treated steel varieties or from hardenable steel varieties, temperature management within the hardening process is of high significance and has a direct influence on the increases in strength that are achievable. In the case of heat-treated steel varieties, by way of temperature management influence is exerted in a targeted manner on the ratio of strength vs. toughness, such that variations of the mechanical properties of the heat-treated steel part also arise in the event of temperature variations. In the case of hardenable steel varieties, influence may be exerted on the microstructure by way of the cooling operation once heating beyond the austenitizing temperature AC₁ has been performed, so that martensitic regions which enable a high increase in strength may be created in a targeted manner. The steel part for heat-treating or hardening is usually heated in a first device and brought up to the desired temperature. The steel part is subsequently transported to a further device in which said steel part by way of a hardening medium is intensively cooled so that the desired modifications take place in the microstructure in the steel part. To this end, transporting devices which are suitable for transporting steel parts having corresponding temperatures of more than 650° C. are used. Only materials which are resistant to high temperatures, inter alia steel, may be considered as materials here. An important aspect when transporting to the hardening or hot forming tool is that the steel part has to be able to be fed immediately to the hardening process or the hot forming process, respectively, without for example recourse to comparatively long reheating up to the hardening or hot forming temperature, respectively. If the material temperature of the steel part becomes too low prior to the hardening process, for example, hardening of the steel part cannot be achieved completely or to the maximum, respectively, in this case. On account of their comparatively minor mass and comparatively large surface, thin-walled steel parts in particular suffer a relatively rapid loss of temperature once they have been removed from the device for heating the steel parts, such that undesirable drops in temperature may already arise during transporting between the device for heating the steel part and the device for hardening the steel part, for example. Initial microstructural transformations may already take place prior to the targeted cooling by way of the hardening medium, for example, such that the strength values achievable by hardening subsequently may not be achieved. This applies in particular also to the hardenable steel varieties. Given the high microstructural transformation temperatures of more than 800° C., for example, the temperature loss in the steel parts during transporting is particularly high on account of the high temperature differential in relation to the ambient room air.

A device for heating electrically conductive and coated or non-coated blanks, for example, which may also be employed for transporting the blanks and in which heating of the material during transporting is to be achieved by an electric current flow is disclosed in DE 10 2005 018 974 A1. However, it has been established that the heating which is generated by the current flow is relatively inhomogeneous, since said heating depends in particular on the current density which may be kept at a constant level across the area of the steel part only with great complexity. Consequently, the operational reliability in achieving the maximum hardness of the entire steel part remains open to improvement, even with this prior art being considered.

Proceeding therefrom, it is therefore an object of the present invention to provide a device and a method for transporting steel parts, which in each case ensure that the temperatures of the steel part which are required for hardening or heat-treatment, respectively, are adhered to in an operationally reliable manner.

According to a first teaching of the present invention, the object described above is achieved in that means for heating the steel parts by induction, convection, and/or radiation are provided. By disposing means for heating the steel parts by induction, convection, and/or radiation, said steel parts may be heated specifically to the desired forming temperature or be kept at the temperature already existent. In contrast to heating the steel parts by an electric current flow, it may be ensured by selecting inductive, convective, or radiative heating means that a homogeneous transmission of heating energy across a large area to the steel parts is enabled and a constant temperature level may thus be adhered to in the entire steel part. On account of the introduction of heat across a large area, the steel part may be kept at a temperature in a homogeneous manner. Unwanted losses in temperature and a drop of the temperature in the steel parts may thus be prevented in particular. Steel parts to be considered include semi-finished products, such as raw materials, profiles, hollow profiles, tubes, or else blanks or sheets.

Said steel parts preferably have particularly minor wall thicknesses of maximum 1.2 mm, maximum 1.0 mm, maximum 0.8 mm, or maximum 0.5 mm, and at least in part are composed of a heat-treatable or hardenable steel. In the case of the minor wall thicknesses the heat losses without the use of heating means during transporting of the steel parts are relatively high. Planar blanks, in which the surface-to-volume ratio is very high, in particular benefit from uniform heating by convection, induction, or by radiated heat.

According to a first embodiment of the present invention, means for heating the regions of the transporting receptacle which are in contact with the steel part by convection, conduction, and/or radiation are provided. These means thus heat the transporting receptacle and may thereby reduce the heat loss of the steel part, which is created by contact of the steel part with the transporting receptacle, or even lead to the steel part being heated at the contact points. In particular, the heat loss of the steel part which is disposed in the transporting receptacle is minimized by the use of means for heating the regions of the transporting receptacle which are in contact with the steel part by convection, conduction, and/or radiation.

If the transporting device according to a further embodiment is configured as a robot, a linear transfer device, or a tube and/or roller system, the most varied heating devices, for example continuous furnaces or tower furnaces, from which the transporting device transports away the steel parts for further processing, that is to say for hot forming and/or hardening, may be used as heating devices for the steel parts. A tube system differs from the roller system in that the tubes, as opposed to the rollers of the roller system, are not rotatably mounted. Transfer of the steel parts is performed in that the tubes of the tube system engage in clearances of the exit region of a furnace, for example, and in this way remove a heated steel part from the furnace. Said tube system in its construction is thus simpler than a roller system.

The transporting device is preferably provided as a tube and/or roller system in which the rollers and/or tubes which are in contact with the steel part are heatable. A tube and/or roller system in a simple manner ensures transportation of a steel part across the tubes and/or rollers used, wherein additional heating energy may be introduced into the steel parts by way of the heatable rollers and/or tubes which are in contact with the steel part, so that an undesirable drop in the temperature may be prevented.

Heatable rollers and/or tubes may be provided in a particularly simple manner in that according to a further embodiment the rollers and/or tubes are heatable using a medium and/or are electrically heatable. Electrically heatable rollers of a roller system or tubes of a tube system, respectively, need only be equipped with electric heating elements in order for correspondingly temperature-controlled rollers and/or tubes to be provided. However, simple heating of the rollers and/or tubes is also conceivable by way of supplying hot media, for example an inert gas which has been heated to high temperatures. It is also conceivable for the exhaust air from the heating device to be used as a hot medium for heating the tubes and/or rollers.

The transporting device may be advantageously designed in that the transporting receptacle has a plurality of heating circuits which may be actuated separately from one another. On account of the heating circuits of the transporting receptacle which are separately actuatable and which have, for example, separate electric heating elements or connectors for hot media dedicated to in each case one roller, additional electrical energy may be saved by impinging only those regions of the transporting receptacle with heating energy that are currently in contact with the steel part.

The transporting device may furthermore be advantageously designed in that electromagnetic heating radiators for heating by radiation, blowers carrying hot media for heating by convection, or induction coils for heating by induction are provided as means for heating the steel parts. It is a common feature of all heating means that these are able to heat the steel parts in a non-contacting manner across a region comprising a large area and thus lead to homogeneous heating of the steel parts.

Finally, the transporting device is advantageously designed in that the transporting receptacles are configured so as to be open. Open in the context of the present invention means that the transporting receptacles have no casing which would complicate the handling of the heated steel parts. On account thereof, transportation of the steel parts may be visually tracked without additional auxiliary means in particular. Moreover, it is achieved by way of the open construction of the transporting receptacles that inhomogeneities in the heating of the steel parts do not arise. Hot spots are avoided in principle by the open construction.

According to a further teaching of the present invention, the object outlined above is achieved by a method for transporting steel parts in that using means for heating the steel part by convection, induction, or radiation, the temperature of the steel part is at least kept constant during transporting to the device for hardening, hot forming, or press hardening. As has already been mentioned, on account thereof, the steel parts in the transporting device may be impinged with heating energy across a large area and in a homogeneous manner so that the temperature of the steel part may be kept constant in a homogeneous manner. Consequently, the hardening operation or hot forming or press hardening of the steel part, respectively, may be carried out in an operationally reliable manner and with the maximum increase in strength. On account of this measure, moreover even comparatively long transporting paths between the device for heating the steel parts and the respective hardening tool or hot forming tool or press hardening tool, respectively, may be implemented without an undesirable drop in temperature in the steel part arising.

According to a further embodiment of the method according to the invention, the temperature of the steel part is further increased during transporting. On account thereof, the potential for the steel parts initially not to be fully heated to the forming temperature and for the loss of heat during transporting to be kept low exists. At the end of transportation the steel parts then have an increased temperature which may then correspond to the forming temperature or the hardening temperature, for example. On account thereof, the operational reliability of the hot forming operation or of press hardening or hardening may be likewise improved, since heat losses during insertion of the steel part into the hardening tool and/or pressing tool may also be considered, for example.

The method according to the invention is particularly preferably carried out using steel parts having a wall thickness of maximum 1.2 mm, maximum 1.0 mm, maximum 0.8 mm, or maximum 0.5 mm. In the case of the minor steel-part wall thicknesses mentioned the loss of heat at the correspondingly high temperatures, for example at a temperature of 950° C., in relation to the room temperature is particularly high, such that the temperature of the steel part in the absence of the method according to the invention rapidly drops and microstructural transformations which at this point in time are undesirable arise.

If transporting of the steel parts is performed using a robot, a linear transfer device, or using a roller system, wherein the transporting receptacles which receive the steel parts are optionally heated by means for heating by convection, conduction, and/or radiation, steel parts may be removed from arbitrary furnaces, continuous furnaces, or tower furnaces, for example, and be fed to the further forming or hardening steps even in the case of comparatively long transporting paths, without undesirable heat losses arising. On account of the transporting receptacles being heated, minimal heat loss by way of contact with the transporting receptacles is ensured, and maintaining the required temperature is thus facilitated.

If the supply of thermal energy according to a further embodiment of the method is also by way of contact with heatable rollers of the roller system or tubes of the tube system, respectively, which are heated using hot media and/or by an electric current, the transporting receptacle of the transporting device may be heated in a simple manner, such that the heat loss of the steel parts during transporting using the tube and/or roller system is reduced.

According to a further embodiment, energy savings may be achieved in that in the case of a tube and/or roller system the heatable tubes and/or rollers have a plurality of heating circuits and individual heating circuits may be actuated during transporting. Individual heating circuits may be formed either electrically or else using hot media, for example, such that heating of only those tubes and/or rollers which are in direct contact with the steel part is performed, for example.

Finally, the method according to the invention is particularly advantageous when the temperature of the steel part during transporting is kept at or increased to at least 750° C., preferably at least 800° C. The loss of heat of the steel parts, in particular of thin-walled steel parts, is particularly high at these high temperatures, so that operational reliability is improved in a particularly effective manner by the method according to the invention.

The invention is to be explained herebelow in more detail by means of exemplary embodiments in conjunction with the drawing in which:

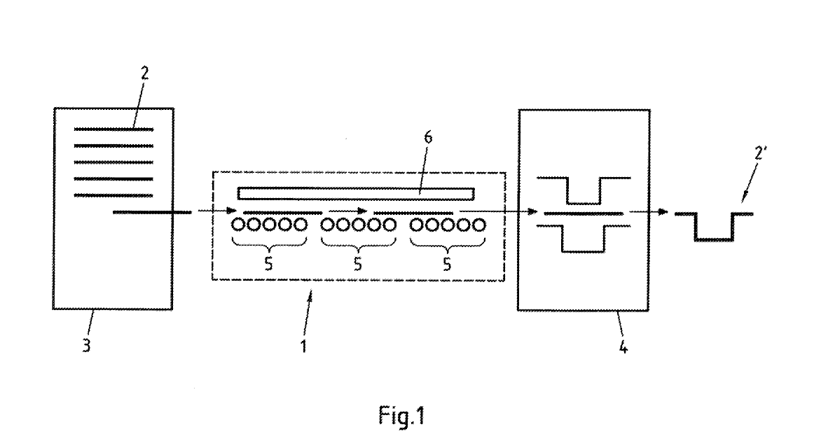

FIG. 1 in a schematic illustration shows the complete procedure of the method, for example in hot forming of steel parts;

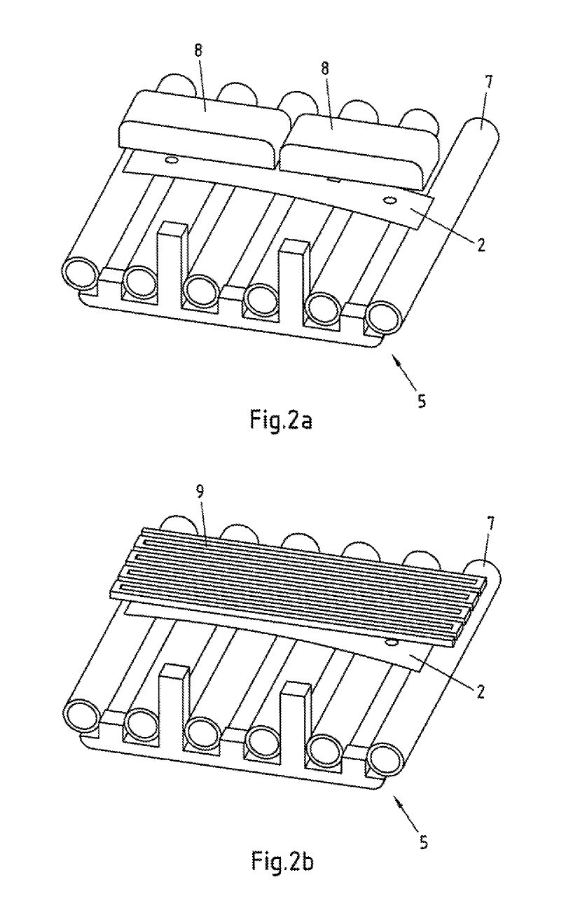

FIGS. 2a, b in a perspective and schematic illustration show the transporting receptacles of a transporting device; and

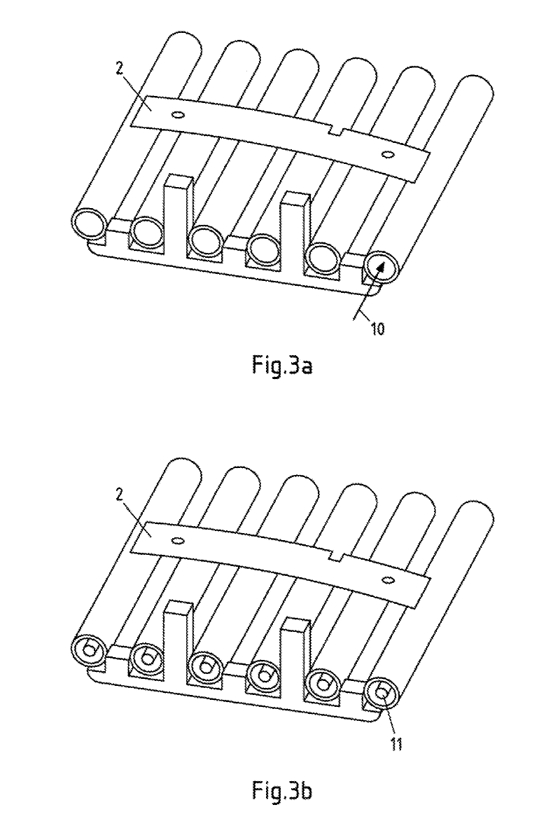

FIGS. 3a, b show two further exemplary embodiments in a schematic and perspective illustration of the transporting receptacles of a transporting device.

FIG. 1 initially shows a schematic illustration of a method for hot forming or hardening steel parts 2 which by way of a transporting device 1 are transported from a furnace 3 to a tool 4 for press hardening or hot forming. A roller system having individual transporting receptacles 5 having a plurality of rollers is provided in the transporting device which is configured so as to be open, as is indicated by the dashed lines. Furthermore, means 6 for heating by convection, induction, or radiation are provided, which keep the steel parts 2 at temperature during transporting. By selecting a non-contacting heating by induction, radiation, and/or convection it is possible for homogeneous heating of the steel part 2 to be achieved in a simple manner, such that forming in the tool 4 may be carried out in an operationally reliable manner at the desired forming temperature. The formed steel part 2′ then has the desired strength throughout the steel part.

In the exemplary embodiments the transporting receptacles 5 of a roller system and/or of a tube system, which here are described in an exemplary manner to represent the transporting receptacles of arbitrary transporting devices 1, for example robots or linear transfer devices, are illustrated in FIGS. 2a, b, and FIGS. 3a, b. In place of the rollers of a roller system or tubes of a tube system, respectively, as are shown in FIGS. 1, 2, and 3, other arbitrary transporting receptacles may thus also be used, for example simple receptacles or stackers for the steel parts, which are then transported by way of robots or linear transfer devices.

FIGS. 2a, b in a perspective illustration now show the transporting receptacle 5 of a transporting device (not illustrated) in the form of a roller system and/or tube system, which transports steel parts 2 from a furnace 3 to a device 4 for hot forming or hardening the steel parts, respectively. The transporting receptacle 5 forms part of a roller system and/or tube system and has a plurality of rollers and/or tubes 7. Moreover, in FIGS. 2a and 2b in each case one means for heating the steel part 2 in the form of an infrared radiator or a hot-air supply 8, or in the form of induction coils 9 (FIG. 2b) is illustrated. Infrared radiators 8 and induction coils 9, respectively, are means for heating the steel parts 2 by radiation and may impinge the steel parts 2 with thermal energy across a large area, such that said steel parts 2 maintain the temperature to which they have previously been heated in the furnace in a homogeneous manner. In place of the heating radiator 8 a hot-air blower or a simple supply of hot air or of a hot medium, respectively, may be provided, such that the steel parts 2 are brought up to a temperature or are kept at this temperature by convection, respectively. The exhaust heat of a furnace may also be used as a hot medium for heating the steel parts 2, for example. It is particularly advantageous for the steel parts to be heated to the hot forming temperature in the transporting receptacle 5, since the loss of heat during transporting is reduced in this way. As can be seen by means of FIGS. 2a and 2b, the transporting receptacles of the transporting device are configured so as to be open and without a casing. In this way, the steel parts are available during transporting and hot spots may be avoided on account thereof.

A further reduction in heat loss of the steel parts 2, which have wall thickness of maximum 1.2 mm, maximum 1.0 mm, in particular maximum 0.8 mm, and particularly preferably maximum 0.5 mm, during transporting is achieved in that the rollers and/or tubes 7 are heated, as is illustrated in FIG. 3. To this end, heated media 10 or, for example, hot gas 6, are used for heating the tubes and/or rollers, as is indicated in FIG. 3a. The exemplary embodiment of a heated transporting receptacle 5 from FIG. 3b has electric heating elements 11 which are provided in the rollers and or tubes and which, using electricity, ensure heating of the rollers and/or tubes 7. Contact between the transporting receptacle 5 and the steel part 2 during heating of the transporting receptacle regions which are in contact with the steel parts leads to a further reduction in heat losses. As has already been mentioned at the outset, the tube and/or roller systems are manufactured from a material which is specified for heating to temperatures of more than 650° C., that is to say from steel, for example. The steel parts, in particular in the case of hardenable steel varieties being hot formed, indeed have temperatures of more than 750° C., preferably more than 800° C.

1.-15. (canceled)

16. A transporting device for transporting steel parts for at least one of hot forming or hardening, comprising:
a plurality of transporting receptacles configured to hold and transport steel parts having temperatures greater than 650° C.; and
means for heating the steel parts by at least one of induction, convection, or radiation.

17. The transporting device of claim 16, wherein said means for heating the steel parts is a means for heating regions of the transporting receptacles that are in contact with the steel parts by at least one of induction, convection, or radiation.

18. The transporting device of claim 16, wherein the transporting device is configured as at least one of a robot, a linear transfer device, a tube system, or a roller system.

19. The transporting device of claim 16, further comprising a roller system having at least one of a plurality of heatable rollers or tubes configured to be in contact with the steel parts.

20. The transporting device of claim 19, wherein said at least one of a plurality of heatable rollers or tubes are at least one of electrically heatable or heatable by use of a heating medium.

21. The transporting device of claim 16, wherein said transporting receptacles comprise a plurality of heating circuits that are each configured to be actuated separately from one another.

22. The transporting device of claim 16, wherein said means for heating the steel parts are at least one of electromagnetic heating radiators configured to heat the steel parts by radiation, blowers carrying hot media configured to heat the steel parts by convection, or induction coils configured to heat the steel parts by induction.

23. The transporting device of claim 16, wherein said plurality of transporting receptacles are open transporting receptacles.

24. A method of transporting steel parts from a device for heating steel parts to a device for at least one of hardening, hot forming, or press hardening the steel parts, comprising:
providing a device as described in claim 16;
heating a steel part to a predetermined first temperature above room temperature;
transporting the steel part to the device for at least one of hardening, hot forming, or press hardening the steel parts; and
during said transporting step, simultaneously maintaining the heated steel part at a constant temperature by use of the means for heating the steel part by at least one of induction, convection, or radiation.

25. The method of claim 24, further comprising increasing the temperature of the steel part during said transporting step.

26. The method of claim 24, wherein a wall thickness of the steel part is a maximum of 1.2 mm.

27. The method of claim 24, further comprising:
receiving the steel part in a transporting receptacle prior to said transporting step; and
heating the transporting receptacles by at least one of convection, conduction, or radiation,
wherein said transporting step comprises transporting the steel part in the transporting receptacles, and wherein said transporting step is performed by at least one of a robot, a linear transfer device, or a roller system.

28. The method of claim 24, wherein said heating step comprises contacting the steel part with at least one of heatable rollers of a roller system, or heatable tubes of a tube system, wherein said heatable rollers or heatable tubes are heated by a hot media or an electric current.

29. The method of claim 24, wherein said maintained constant temperature of the steel part during said transporting step is at least 750° C.

30. The method of claim 28, further comprising, during said transporting step, actuating individual heating circuits of the at least one of heatable rollers or tubes.
